(19) United States
(12) Patent Application Publication
(10) Pub. No.: US 2024/0177220 A1
(43) Pub. Date: May 30, 2024

(54) REDUCED WAIT TIME ORDER PROCESSING

(71) Applicant: NCR Corporation, Atlanta, GA (US)

(72) Inventors: William Jarome Gautreaux, Macon, GA (US); Sarthak Mohanty, Powell, OH (US); Shivam Amit Patel, Marietta, GA (US); Razat Talapatra Sutradhar, Tucker, GA (US)

(21) Appl. No.: 18/072,648

(22) Filed: Nov. 30, 2022

(51) Int. Cl. G06Q 30/0601

(52) U.S. Cl. CPC G06Q 30/0635

(57) ABSTRACT

Cameras capture images of customers queued for in-store orders at stores. The images are processed to count a total number of customers in the queues at each store. Concurrently, an online and unfulfilled total order count for each store is obtained. When an online order is placed by a customer through an order application, the stores are filtered to identify candidate stores within a configured distance of a current location of the customer. The current and up-to-date counts for the in-store queues and online orders are evaluated to select a store from the candidate stores that is capable of fulfilling the order in the shortest amount of time. The order is routed to and placed with the selected store on behalf of the customer.

### BACKGROUND

During rush hour for stores and restaurants, many online orders may not get fulfilled in a reasonable amount of time, which could result in loss of future business from certain customers. Pandemic-induced labor shortages have exacerbated order fulfillment delays, prompting more and more consumers to embrace third-party ordering services for placing online orders with stores and restaurants. Unfortunately, these third-party services usually only inform the consumers of the wait times for pickup or delivery after the consumer selects the store/restaurant and sometimes only after the consumer's order is placed. However, once the order is confirmed by a store, the consumer may not be able to cancel the order through the third-party service.

Online ordering for pickup and delivery exploded during the COVID pandemic and the trend has not substantially abated even as pandemic-related lockdown restrictions have been lifted. As a result, wait times have increased across the board—for both in-store in-store orders as well as online orders. As noted above, these delays have been further exacerbated by a shortage of retail workers who were either let go or quit during the pandemic and/or who did not return to work as the pandemic eased. in-store Many consumers have become frustrated with the increased wait times and are becoming more prone to abandoning retailers with whom they've experienced long wait times for different retailers.

### SUMMARY

In various embodiments, methods and a system for reduced wait time order processing are presented. Current queue counts of customers waiting to place in-store orders are stores are derived from real-time images of the queues. Current online and unfulfilled order counts are obtained for each of the stores. When a customer places an online order for a given store through an online ordering application, the stores are filtered into candidate stores based on a configurable distance between a current location of the customer and the stores. The queue counts and online order counts for the candidate stores are evaluated to select a store capable of fulfilling the customer's order within the shortest amount of time. The order is routed to and placed with the selected store on behalf of the customer via an order system associated with the online ordering application.

### BRIEF DESCRIPTION OF THE DRAWINGS

FIG. 1A is a diagram of a system for reduced wait time order processing, according to an example embodiment.

FIG. 1B is a flow diagram of a method for reduced wait time order processing, according to an example embodiment.

FIG. 2A is a flow diagram of another method for reduced wait time order processing, according to an example embodiment.

FIG. 2B is a flow diagram of embodiments of the method of FIG. 2A, according to an example embodiment.

FIG. 3 is a flow diagram of yet another method for reduced wait time order processing, according to an example embodiment.

### DETAILED DESCRIPTION

As stated above, take-out orders placed for in-store pickup or delivery have substantially increased in recent years. At the same time, stores are experiencing a greater amount of staffing shortages. Consumers may place orders for pickup or delivery via online services of a given retailer and/or via third-party order and delivery services. An increasingly fewer number of consumers are placing orders via the phone these days, and in some cases, stores are no longer even accepting phone orders.

Due to the simultaneous increase in online ordering and the staffing shortages experienced by retailers, consumers are increasingly facing unreasonable wait times for their order can be picked up or delivered. This is resulting in significant consumer dissatisfaction and causing many consumers to abandon even retailers with whom they've had long-established relationships for other retailers where the wait times are more tolerable. A concern for retailers who lose consumers in this manner is that the consumers who switch retailers may actually prefer the food/product of the new retailer and may not return to their previous preferred retailers. Moreover, rampant inflation is driving down demand somewhat as consumers fiscally tighten up on their discretionary spending. Despite this reduced demand, wait times at some retail stores have still not improved due to continued staffing shortages. This is especially true during peak order hours, such as dinner time or during a popular sporting event.

The teachings presented herein and below provide technical solutions to the above-described problems. A cloud-based order balancing service is provided that utilizes a variety of factors to load balance online orders and in-store orders for purposes of selecting, for a given consumer, an alternative store with wait times that are acceptable to the consumer. The cloud service maintains a current count of customers in queues waiting to order at the stores as well as a count of pending online orders for the stores. When a customer is placing an order with a retailer, via a retailer-hosted service or a third-party service, the cloud service selects an optimal store for placing the order of the customer based on a calculated estimated wait time to fulfill the order and based on a current location of the customer vis-à-vis available store locations. In example embodiments, cloud service selects an optimal store for the consumer such that pickup or delivery at the optimal store is associated with least amount of time for order fulfillment. The cloud service also integrates into order workflows associated third-party order systems and retailer-hosted order systems, such that the cloud service is transparent to the consumer.

As used herein the terms “consumer,” “user,” and “customer” may be used synonymously and interchangeably and may refer to an individual who is placing an online order using an order application associated with a third-party order system or retailer-hosted order system.

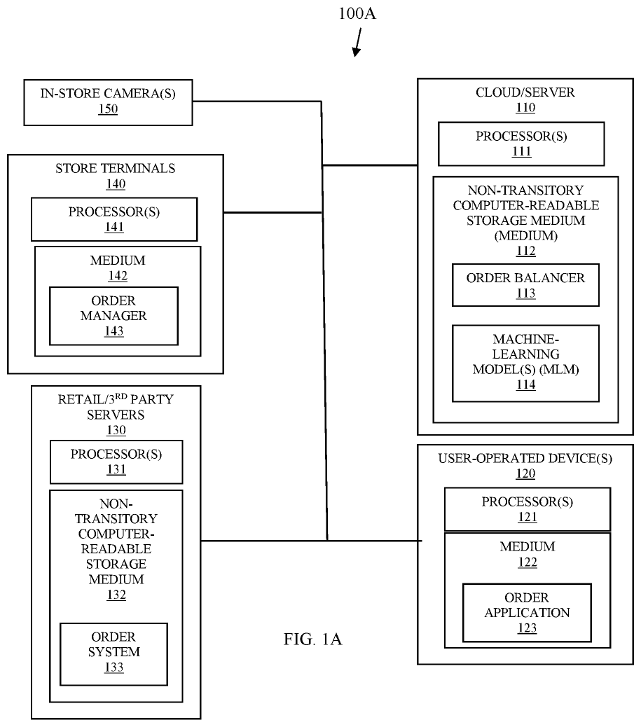

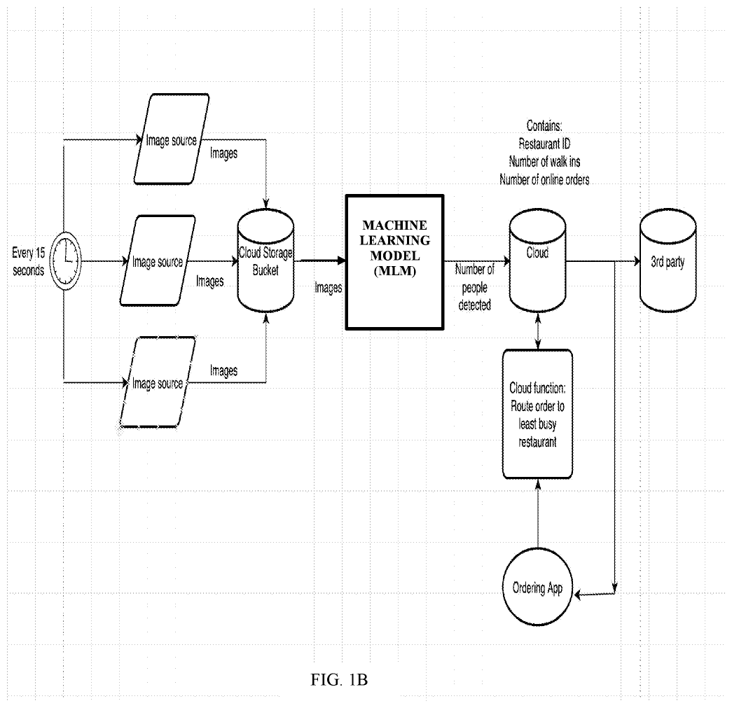

FIG. 1A is a diagram of a system 100A for reduced wait time order processing, according to an example embodiment. The system 100A is shown schematically in greatly simplified form, with only those components relevant to understanding of one or more embodiments (represented herein) being illustrated. The various components are illustrated, and the arrangement of the components is presented for purposes of illustration only. It is to be noted that other arrangements with more or less components are possible without departing from the teachings of the reduced wait time order processing presented herein and below.

Moreover, various components are implemented as one or more software modules, which reside in non-transitory storage and/or hardware memory as executable instructions that when executed by one or more hardware processors perform the processing discussed herein and below.

System 100A includes a cloud 110 or a server 110 (hereinafter referred to as “cloud 110”), user-operated 120, retail or third-party servers 130, store terminals 140, and in-store cameras 150. Cloud 110 includes at least one processor 111 and a non-transitory computer-readable storage medium (hereinafter “medium”) 112, which includes an order balancer 113 and a machine-learning model (MLM) 114. The order balancer 113 and the MLM 114 comprise respective executable instructions, that when provided to processor 111 cause processor 111 to perform operations discussed herein and below for 113 and 114, respectively.

Each user-operated device 120 includes at least one processor 121 and medium 122, which includes an order application 123. The order application 123 comprises executable instructions, which when provided to processor 121 cause processor 121 to perform operations discussed herein and below for 123.

Each retail or third-party server 130 includes one or more processors 131 and medium 132, which includes an order system 133. The order system 133 comprises executable instructions, which when provided to processor 131, cause processor 131 to perform operations discussed herein and below for 133.

Each store terminal 140 includes one or more processors 141 and medium 142, which includes an order manager 143. The order manager 143 comprises executable instructions, which when provided to processor 141, cause processor 141 to perform the operations discussed herein and below for 143.

Each store also includes one or more in-store cameras 150. Cameras 150 provide a live and real-time video feed of customer queues at the corresponding store terminals 140 including images of customers waiting to place orders within the corresponding store.

During operation of system 100, real-time video feeds of customer queues at terminals 140 within the stores are streamed to order balancer 113 or to a network storage location that is accessible by order balancer 113. At preconfigured intervals of time, the video feeds for each store may be obtained. At the preconfigured intervals of time, balancer 113 may also access the order systems 133 associated with orders at each store to obtain a current unfulfilled pending online order count for each store. Balancer 113 also maintains a mapping between each store's identifier, the retailer identifier corresponding to the store identifier, and a known geographic location for the store.

When a customer is operating application 123 (hereinafter just “app 123”) to place an order and has selected a store within the user interface of app 123, order system 133 may leverage an application programming interface (API) to provide order balancer a user identifier for the user, a store identifier for the store, and a current geographic location of the user based on device 120 as determined from location information received by the order system 133 from the app 123. Balancer 113 may use the mapping to obtain the retailer identifier linked to the store and to determine store identifiers for other stores associated with the same retailer identifier.

Next, balancer 113 may filter the list of store identifiers to retain only those store identifiers linked to stores that are within a preconfigured distance from the user's current location. For example, only records for stores that are within 2 miles of the user's current location may be retained. This filtering may provide balancer 113 with a set of candidate stores that are within an acceptable distance of the user. Balancer 113 may then obtain a set of images of the queues at the terminals 140 of the candidate stores for a current interval of time as well as current counts of pending and unfulfilled online orders associated with the candidate stores.

Order balancer 113 may pass a data set of records for the candidate stores to the MLM 114 as input features. The input features for each record may include a store identifier for the store, the corresponding images of the queues, and the current count of pending and unfulfilled online orders for the corresponding store identifiers. The MLM 114 may be trained to select an optimal store that has the least amount of wait time for any potential order that is to be placed among the stores associated with the records. The MLM 114 may be trained to identify, from the images, a current count of customers in a queue to place an order at each store and may use the current customer counts along with the current online order counts to select, as an optimal store, the candidate store that is able to fulfill a potential order in the shortest amount of time.

Order balancer 113 may use an API to return the store identifier to order system 133 for the current order being placed by the user through app 123. Order system 133 may provide the user with details such as address, directions, and store name within the user interface of app 123. The user can select the suggested store or stay with the user's first choice of stores to receive the order. Order system 133 receives the order from the user through the user interface of app 123 and places the order with the corresponding order manager 143 of the user-selected store.

In an embodiment, MLM 114 is further trained to produce calculated order wait times for each of the stores represented among the input features received by balancer 113. MLM 114 produces a sorted list as output that includes each store's identifier and the corresponding predicted order wait time. Balancer 113 sends the list via an API to order system 133 and order system 133 presents the store names, addresses, and predicted wait times within the user interface of app 123, such that the user can select a desired store with which to place an order.

In an embodiment, balancer 113 uses image processing techniques to count customers in the queues from the video feeds and to store in a database the counts for each store during each of one or more intervals of time. In this embodiment, the candidate records provided as input features to MLM 114 include store identifiers, corresponding customer queue counts for each store identifier, and corresponding online order counts for each store identifier.

In an embodiment, MLM 114 is trained to receive images of the queues at the terminals 140 of the stores and produce, as output, a current customer queue count for each store. Balancer 113 obtains the online order count from the order system 133 at the same interval of time that the images processed by MLM 114 are captured and stores records in a database for each store and each interval of time that include the store identifiers, current customer queue counts, and current online order counts. When an order is being processed through a given system 113, balancer uses the mapping and preconfigured distance relative to the current location of a given user to filter the current records to obtain candidate records. Balancer 113 may use a second MLM 114 or heuristics to obtain an estimated order wait time for the current order for each store in the candidate records. Balancer 113 returns a sorted list of the records to the corresponding order system 133. The list may be sorted from lowest calculated order wait time to highest calculated order wait time.

In an embodiment, order balancer 113 determines which store a current order should be placed with based on the calculated order wait times for the current order for each of the candidate stores within a configured distance of the user's current location. The selected store may be the candidate store associated with the shorter calculated order wait time. Balancer 113 automatically routes the order to order manager 143 of the store and notifies the corresponding order system 133 that the order was placed on behalf of the user at the selected store.

In an embodiment, the user interface of app 123 permits the user to select an option that automatically determines and routes an order to a store with the shortest order wait time. In an embodiment, the configured distance for the candidate stores for receiving a current order can be set by the user within the user interface of app 123. In an embodiment, the configured distance for the candidate stores for receiving the current order can be a user setting within a profile maintained by an order system 133 for the user.

In an embodiment, when a user's order is identified by balancer 113 from system 133, balancer 133 obtains real-time images of the queues for the stores determined to be within a preconfigured distance of the user and obtains a real-time online order count for each of the stores from system 133. In this embodiment, balancer 113 processes real-time information for each of the stores rather than using information associated with a last processed or current interval of time.

In an embodiment, the customer queue counts, online order counts, store identifiers, and date and time stamps for each interval of time are retained in a data store as historical information. The data store can be subsequently mined by the retailer, cloud 110, and/or third-party applications for trends and patterns with respect to each of the stores associated with each of the retailers. An example of such a trend or pattern many be that a given store of a given retailer experiences an unusually high or low volume of online orders at a given time of day, day of week, and/or day of month in relation to, for example, a monthly average of online orders. Two or more stores within a preconfigured distance of one another can also be evaluated relative to one another from the historical information to identify different trends for the different stores. For example, it may be determined that store A experiences high online order counts on Fridays, while store B experiences high online order counts on Thursdays and Sundays. A variety of mining and reporting for relationships, patterns, and trends can be provided through the data store of historical information.

FIG. 1B is a flow diagram of a method 100B for reduced wait time order processing, according to an example embodiment. It is to be noted that method 100B represents one embodiment of system 100A and other embodiments are also available as was discussed above with FIG. 1A.

Initially, cameras 150 are configured to stream video feed snapshots from the stores and their terminals 140 every X seconds (e.g., the preconfigured interval of time as discussed with system 100A may be set to 15 second intervals of time). Cameras 150 are labeled as “image sources” in FIG. 1B. The video feed snapshots are buffered or stored in a cloud storage bucket and fed at each interval of time to MLM 114. MLM 114 outputs the store identifier and a customer queue count for a current interval for the corresponding store, which is then stored in a cloud data store or cloud database. Concurrently, balancer 113 or a separate application collects current online order counts for each store via their corresponding systems 133 and stores the counts within the cloud data store. Records in the cloud data store include, for each record, the store identifier, the corresponding customer queue count, and the corresponding online order count.

When a given order is being processed via app 123, balancer 113 accesses the current records from the cloud data store and filters the records into candidate records based on a current location of the user and the preconfigured distance from the current location to the stores using the mapping discussed above with system 100A. Balancer 113 then performs a cloud function to route the current order to the least busy store or restaurant by placing the order defined within app 123 with the corresponding order manager 143 of the selected store.

In an embodiment, the records for the stores housed in the cloud data store are offloaded and stored in a third-party data store as historical records for the stores. Cloud-based applications, retailer-based applications, and/or third-party applications can be given access to the third party data store for purposes of deriving relationships, patterns, and trends for online ordering at the stores.

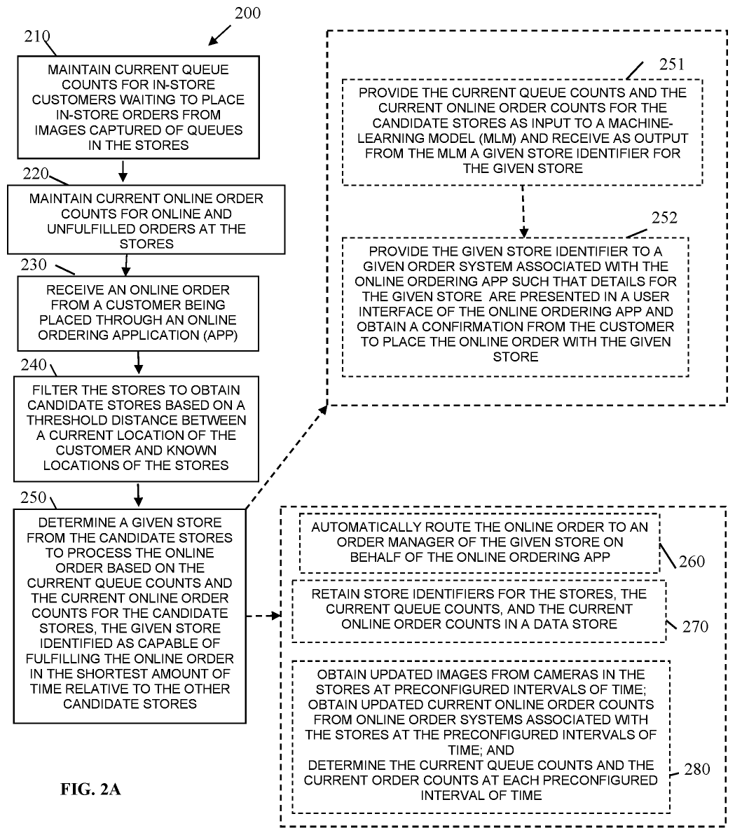

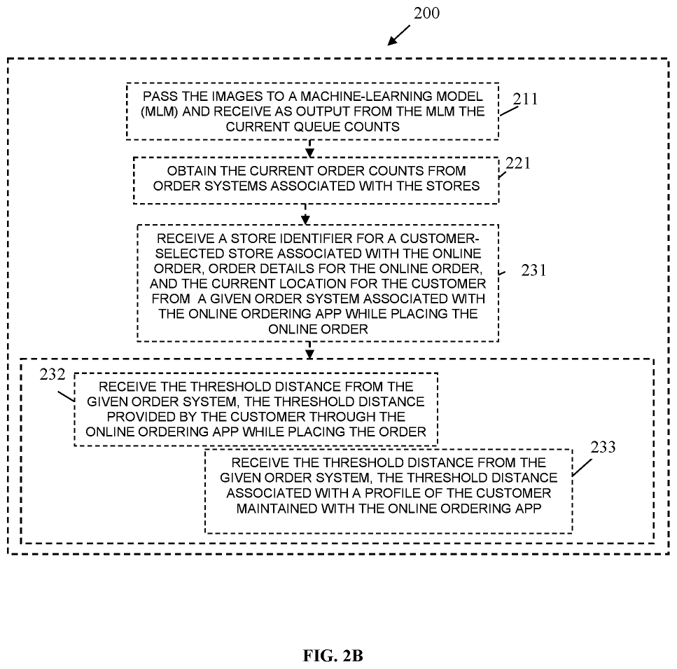

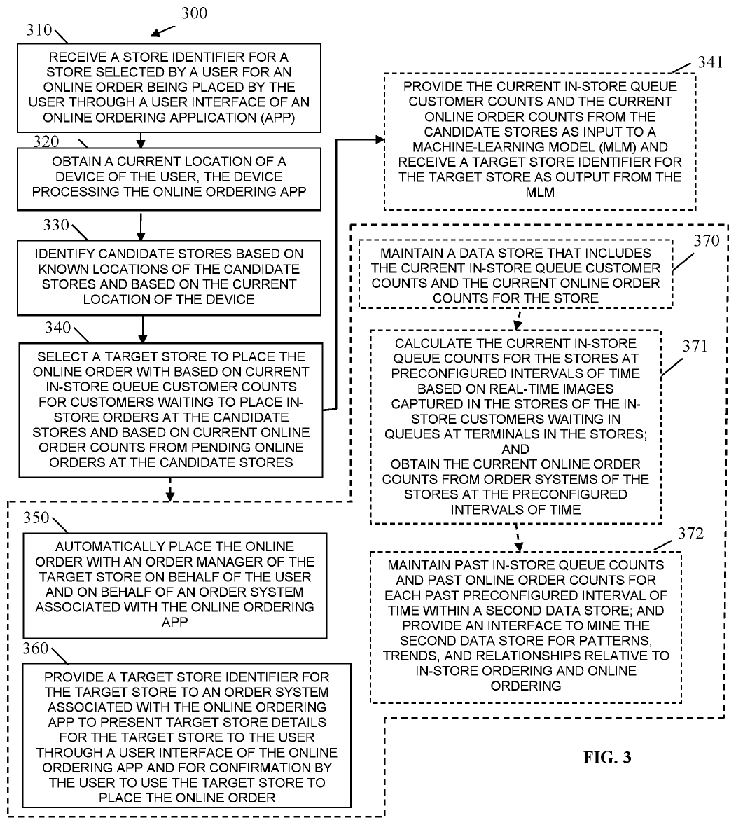

The embodiments of FIGS. 1A and 1B and other embodiments are now discussed with reference to the FIGS. 2A, 2B, and 3. FIGS. 2A and 2B are flow diagrams of a method 200 for reduced wait time order processing, according to an example embodiment. The software module(s) that implements the method 200 is referred to as an “order balancer.” The order balancer is implemented as executable instructions programmed and residing within memory and/or a non-transitory computer-readable (processor-readable) storage medium and executed by a plurality of hardware processors of a plurality of hardware computing devices. The processors of the devices that execute the order balancer are specifically configured and programmed to process the order balancer. The order balancer has access to one or more networks during its processing. The networks can be wired, wireless, or a combination of wired and wireless.

In an embodiment, the device that executes the order balancer is cloud 110 or server 110. In an embodiment, the device that executes the order balancer is restaurant/retail server 130 or a third-party ordering server 130. In an embodiment, the order balancer is order balancer 113 and/or MLMs 114.

At 210 (shown in FIG. 2A), the order balancer maintains current queue counts for in-store customers waiting to place in-store orders from images captured of customer queues in the stores. The customers are in queues at terminals 140 of the stores and the images are provided by in-store cameras 150.

In an embodiment (shown in FIG. 2B), the order balancer passes the images to a MLM 114 and receives as output from the MLM 114 the current queue counts. That is, the MLM 114 may be configured to provide the queue counts from live images of queues at terminals 140 using in-store cameras 150.

At 220 (shown in FIG. 2A), the order balancer maintains current online order counts for online and unfulfilled orders at the store. The order balancer obtains the pending order counts from each store from order systems 133 associated with retailers or third-party ordering services.

In an embodiment of 211 and 220, at 221 (shown in FIG. 2B), the order balancer obtains the current order counts from order systems 133 associated with the stores, which may be retailer order systems or third-party online ordering applications.

At 230 (shown in FIG. 2A), the order balancer receives an online order from a customer being placed through an online ordering application 123. An existing workflow of the online ordering application 123 is modified to send the order and store details associated with a customer-selected store to the order balancer.

In an embodiment of 221 and 230, at 231 (shown in FIG. 2B), the order balancer receives a store identifier for a customer-selected store associated with the online order of the customer, order details for the online order, and the current location of the customer from a given order system 133. The given order system 133 is associated with the online ordering application 123 while the online order is being placed by the customer through device 120.

In an embodiment of 231 and at 232 (shown in FIG. 2B), the order balancer receives the threshold distance from the given order system 133. The threshold distance may be provided by the customer through a user interface of the online ordering application 123 while the customer places the order.

In an embodiment of 231 and at 233 (shown in FIG. 2B), the order balancer receives the threshold distance from the given order system 133. The threshold distance may be associated with a profile of the customer and the profile may be maintained with the online ordering application 123 on behalf of the customer.

At 240 (shown in FIG. 2A), the order balancer filters the stores into candidate stores based on a threshold distance between a current location of the customer and known locations of the stores. The device 120 operated by the customer and executing the ordering application 123 may use location services to provide the device location to the ordering application 123, and the ordering application 123 may provide the customer's current location to the order balancer. The order balancer may maintain a threshold acceptable store distance for the customer and scan a mapping to identify candidate stores that can satisfy the customer's order and that are within the threshold acceptable store distance from the current location of the device 120.

At 250 (shown in FIG. 2A), the order balancer provides the current queue counts and the current online order counts for the candidate stores as input to a MLM 114 and receives as output from the MLM 114 a given store identifier for the given store. The MLM 114 then determines the store that is capable of fulfilling the customer's order in a shortest amount of time for customer pickup at the store or for customer delivery to the current location of the customer.

In an embodiment of 250, and at 251 (shown in FIG. 2A), the order balancer provides the given store identifier to a given order system 133 associated with the online ordering application 123 such that details for the given store are presented in a user interface of the online ordering application 123. The order balancer also obtains a confirmation from the customer to place the online order with the given store. In an embodiment, the order balancer does not require customer confirmation and automatically places the customer's order with the given store through the corresponding order system 133.

In an embodiment, at 260 (shown in FIG. 2A), the order balancer automatically routes the online order to an order manager 143 of the given store on behalf of the online ordering application 123. The order balancer can directly place the customer's order with the store through an order manager 143 of a store terminal 140 or can place the order with an order system 133 associated with the store.

In an embodiment, at 270 (shown in FIG. 2A), the order balancer retains store identifiers for the stores, the current queue counts of customers inline, and the current online order counts in a data store. This information can be stored to enable subsequent mining for trends, patterns, and relationships between online orders, in-store orders, and the stores.

In an embodiment, at 280 (shown in FIG. 2A), the order balancer obtains updated images from in-store cameras 150 at preconfigured intervals of time. The order balancer obtains updated current online order counts from online order systems 133 associated with the stores. The order balancer determines the current queue counts and the current order counts at each preconfigured interval of time. In an embodiment, the preconfigured interval of time is 15 seconds.

FIG. 3 is a flow diagram of another method 300 for order balancer, according to an example embodiment. The software module(s) that implements the method 300 is referred to as an “order router.” The order router is implemented as executable instructions programmed and residing within memory and/or a non-transitory computer-readable (processor-readable) storage medium and executed by one or more hardware processors of one or more hardware devices. The processors of the devices that execute the order router are specifically configured and programmed to process the order router. The order router has access to one or more networks during its processing. The networks can be wired, wireless, or a combination of wired and wireless.

In an embodiment, the device that executes the order router is cloud 110 or server 110. In an embodiment, the device that executes the order router is restaurant/retail server 130 or a third-party order server 130.

In an embodiment, the order router is all or any combination of order balancer 113, MLM(s) 114, and/or method 200. The order router presents another and, in some ways, an enhanced processing perspective from that which was discussed above with respect to system 100 and method 200.

At 310, the order router receives a store identifier for a store selected by a user for an online order being placed by the user through a user interface of an online ordering application (app) 123. This can be achieved by enhancing an existing workflow of app 123 to call order router using an API and providing the store identifier.

At 320, the order router obtains a current location of a device 120 of the user. The device 120 processes the online ordering app 123 and is operated by the user while placing the order through app 123.

At 330, the order router identifies candidate stores based on known locations of the candidate stores and based on the current location of the device 120. The candidate stores are stores operating during a same time and/or from a same retailer as the store associated with the received store identifier at 310. Moreover, the candidate stores may be within a predefined distance of the current location of device 120 based on known locations associated with the candidate stores.

At 340, the order router selects a target store to place the online order based on current in-store customer counts for customers waiting to place in-store orders at terminals 140 of the candidate stores and based on current online order counts from pending online orders at the candidate stores. The current in-store customer counts are determined from images captured in real-time or near-real-time of the customers waiting in lines at the terminals 140 within the candidate stores. The current online order counts can be obtained via an API that communicates an order system 133 associated with the candidate stores. It is to be noted that the candidate stores may include the user-provided store for the current online order placed through the online ordering app 123.

In an embodiment, at 341, the order router provides the current in-store queue customer counts and the current online order counts from the candidate stores as input to a MLM 114. The MLM 114 provides as output a target store identifier for the target store. The target store may represent an optimal store from the candidate store that is capable of fulfilling the user's current online order in a shorter period of time than the other candidate stores.

In an embodiment, at 350, the order router automatically places the online order with an order manager 143 of the target store on behalf of the user and on behalf of an order system 133 associated with the online ordering app 123. That is, the order router can route the order details for the order directly to the store and the store can record the order with its corresponding order system 133.

In an embodiment, at 360, the order router provides a target store identifier for the target store to an order system 133 associated with the online ordering app 123. The order system 133 presents target store details for the target store to the user through a user interface of the online order app 123. The order system 133 also receives a confirmation from the user through the user interface of app 123 that indicates the user desires to use the target store to place the online order.

In an embodiment, at 370, the order router maintains a data store that includes the current in-store queue customer counts and the current online order counts for the store. In an embodiment of 371, and at 372, the order router calculates the current in-store queue counts for the stores at preconfigured intervals of time based on real-time images captured in the stores of the in-store customers waiting in queues at terminals 140 within the stores. The order router obtains the current online order counts from order systems 133 of the stores at the preconfigured intervals of time. In an embodiment of 372, and at 372, the order router maintains past in-store queue counts and past online order counts for each past preconfigured interval of time within a second data store. The order router provides an interface to mine the second data store for patterns, trends, and relationships relative to in-store ordering and online ordering of the candidate stores and other stores serviced by order router.

It should be appreciated that where software is described in a particular form (such as a component or module) this is merely to aid understanding and is not intended to limit how software that implements those functions may be architected or structured. For example, modules are illustrated as separate modules, but may be implemented as homogenous code, as individual components, some, but not all of these modules may be combined, or the functions may be implemented in software structured in any other convenient manner.

Furthermore, although the software modules are illustrated as executing on one piece of hardware, the software may be distributed over multiple processors or in any other convenient manner.

The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus, the following claims are hereby incorporated into the Description of the Embodiments, with each claim standing on its own as a separate exemplary embodiment.

1. A method, comprising:
determining, from images captured of customer queues in stores, current queue counts for in-store customers waiting to place in-store orders at the stores;
determining current online order counts for online and unfulfilled orders at the stores;
receiving an online order from a customer, the online order placed through an online ordering application;
filtering the stores to obtain candidate stores based on a threshold distance between a current location of the customer and known locations of the stores; and
determining a given store from the candidate stores to process the online order based on the current queue counts and the current online order counts for the candidate stores, wherein the given store is identified as capable of fulfilling the online order in the shortest amount of time relative each other candidate store.

2. The method of claim 1 further comprising:
automatically routing the online order to an order manager of the given store on behalf of the customer and the online ordering application.

3. The method of claim 1 further comprising:
retaining store identifiers for the stores, the current queue counts, and the current online order counts in a data store.

4. The method of claim 1 further comprising:
obtaining updated images from cameras in the stores at preconfigured intervals of time;
obtaining updated current online order counts from online order systems associated with the stores at the preconfigured intervals of time; and
determining the current queue counts and the current online order counts at each preconfigured interval of time.

5. The method of claim 1, wherein maintaining the current queue counts further includes passing the images to a machine-learning model (MLM) and receiving as output from the MLM the current queue counts.

6. The method of claim 2, wherein maintaining the current order counts further includes obtaining the current order counts from order systems associated with the stores.

7. The method of claim 6, wherein receiving further includes receiving a store identifier for a customer-selected store associated with the online order, order details for the online order, and the current location for customer from a given order system associated with the online ordering application.

8. The method of claim 7, wherein receiving further includes receiving the threshold distance from the given order system, wherein the threshold distance provided by the customer through the online ordering application while placing the online order.

9. The method of claim 7, wherein receiving further includes receiving the threshold distance from the given order system, wherein the threshold distance associated with a profile of the customer maintained with the online ordering application.

10. The method of claim 1, wherein determining further includes providing the current queue counts and the current online order counts for the candidate stores as input to a machine-learning model (MLM) and receiving as output from the MLM a given store identifier for the given store.

11. The method of claim 10 further comprising, providing the given store identifier to a given order system associated with the online ordering application such that details for the given store are presented in a user interface of the online ordering application and obtaining a confirmation from the customer to place the online order with the given store.

12. A method, comprising:
receiving a store identifier for a store selected by a user for an online order being placed by the user through a user interface of an online ordering application;
obtaining a current location of a device of the user, the device processing the online ordering application;
identifying candidate stores based on known locations of the candidate stores and based on the current location of the device; and
selecting a target store to place the online order based on current in-store queue customer counts for customers waiting to place in-store orders at the candidate stores and based on current online order counts from pending online orders at the candidate stores.

13. The method of claim 12 further comprising:
automatically placing the online order with an order manager of the target store on behalf of the user and on behalf of an order system associated with the online ordering application.

14. The method of claim 12 further comprising:
providing a target store identifier for the target store to an order system associated with the online ordering application to present target store details for the target store to the user through a user interface of the online ordering application and for confirmation by the user to use the target store to place the online order.

15. The method of claim 12 further comprising:
maintaining a data store that comprises the current in-store queue customer counts and the current online order counts for the stores.

16. The method of claim 15, wherein maintaining further includes:
calculating the current in-store queue counts for the stores at preconfigured intervals of time based on real-time images captured in the stores of the in-store customers waiting in queues at terminals in the stores; and
obtaining the current online order counts from order systems of the stores at the preconfigured intervals of time.

17. The method of claim 16 further includes:
maintaining past in-store queue counts and past online order counts for each past preconfigured interval of time within a second data store; and
providing an interface to mine the second data store for patterns, trends, and relationships of the stores relative to in-store ordering and online ordering.

18. The method of claim 12, wherein selecting further includes providing the current in-store queue customer counts and the current online order counts from the candidate stores as input to a machine-learning model (MLM) and receiving a target store identifier for the target store as output from the MLM.

19. A system comprising:
at least one server that comprises at least one processor; and
the at least one processor executes instructions that cause the at least one processor to perform operations comprising:
maintaining current customer queue counts for customers waiting to place in-store orders at stores based on images captured of the customers at terminals in the stores;
maintaining current online order counts for online orders that are pending and unfulfilled at the stores;
receiving a store identifier for a given store and online order details for a pending ordering being processed by an online ordering application on behalf of a user;
receiving a current location of a device associated with the online ordering application;
filtering the stores into candidate stores based on the store identifier and based on known locations of the candidate stores being within a preconfigured distance of the current location;
determining a target store to place the pending order with the order details based on the current customer queue counts and the current online order counts for the candidate stores; and
routing the pending order with the order details to an order manager of the target store to place the pending order on behalf of the user and on behalf of the online ordering application.

20. The system of claim 19, wherein the operations are provided and processed by the at least one processor as a cloud-based service integrated into workflows associated with online ordering systems of the stores.
